(19) United States
(12) Patent Application Publication
(10) Pub. No.: US 2026/0342436 A1
(43) Pub. Date: Oct. 29, 2026

(54) DATA OVER CABLE SERVICE INTERFACE SPECIFICATIONS (DOCSIS) TIME DIVISION ORTHOGONAL FREQUENCY-DIVISION MULTIPLEXING (OFDM)

(71) Applicant: Charter Communications Operating, LLC, St. Louis, MO (US)

(72) Inventors: Mustanser Siddique, Aurora, CO (US); Charles Ivan Cook, Castle Rock, CO (US)

(21) Appl. No.: 19/191,936

(22) Filed: Apr. 28, 2025

(51) Int. Cl. H04B 7/26; H04L 12/28

(52) U.S. Cl. CPC H04B 7/2656; H04L 12/2801

(57) ABSTRACT

To share a communications network between legacy and current versions of a data transfer standard, use a scheduler to assign legacy communications using a first modulation technique to a first spectrum portion for communications in a first direction and current version communications using a second modulation technique to a second portion of the spectrum for communications in the first direction. At the scheduler, obtain, over a dedicated upstream signaling channel, from a current version cable modem, a request for a current version communications channel in the first direction using the second modulation technique, and determine that additional bandwidth is required. In response, use the scheduler to signal the modem, using a dedicated downstream signaling channel, to expect the current version communications channel to be provided over the first portion of spectrum using TDMA. With the scheduler, provide the requested channel by using TDMA to divide the first portion of spectrum.

### FIELD OF THE INVENTION

The present invention relates generally to the electrical, electronic and computer arts, and, more particularly, to electronic devices, networking and network management.

### BACKGROUND OF THE INVENTION

Data Over Cable Service Interface Specification (DOCSIS®, registered mark of Cable Television Laboratories, Inc., Louisville, COLORADO, UNITED STATES) is an international telecommunications standard that permits the addition of high-bandwidth data transfer to an existing cable television (CATV) system. It is used by many cable television operators to provide cable Internet access over their existing hybrid fiber-coaxial (HFC) infrastructure.

In the downstream direction, a conventional data over cable service interface specification (DOCSIS) network uses orthogonal frequency-division multiplexing (OFDM) which allocates a portion or the entire downstream spectrum to either one cable modem at a time or allocates a portion or the entire downstream spectrum to be shared by all compatible cable modems in a service group in a broadcast transmit manner. In the upstream direction, the DOCSIS network uses orthogonal frequency division multiple access (OFDMA) which enables multiple parallel streams (subcarriers, i.e., 50 KHz wide per subcarrier) within larger frequency band i.e., 96 MHz wide OFMDA channel, which then allows these streams to transmit simultaneously by one or multiple cable modems to the cable modem termination system (CMTS). It is noted that different users typically have different upstream data transfer rate requirements at any given time and are assigned different modulation schemes based on the receive modulation error ratio (Rx-MER) from each cable modem. This makes OFDMA more efficient, enables the allocation of the optimum bandwidth needed for the specific duration and traffic transfer rate that is needed, and can allow for higher spectral efficiency in the upstream direction.

### SUMMARY OF THE INVENTION

Principles of the invention provide techniques for data over cable service interface specifications (DOCSIS) time division orthogonal frequency-division multiplexing (OFDM). In one aspect, an exemplary method for sharing a communications network between legacy and current versions of a data transfer standard includes the operations of: operating the communications network by using a scheduler component to assign legacy version communications using a first modulation technique to a first portion of spectrum for communications in a first direction and by using the scheduler component to assign current version communications using a second modulation technique to a second portion of the spectrum for communications in the first direction; and, at the scheduler component, obtaining, over a dedicated upstream signaling channel, from a current version cable modem, a request for a current version communications channel in the first direction using the second modulation technique. Further steps include, at the scheduler component, determining that additional bandwidth is required to accommodate the request; responsive to the determining, with the scheduler component, signaling, using a dedicated downstream signaling channel, the current version cable modem to expect the current version communications channel to be provided over the first portion of spectrum using time division multiple access (TDMA); and the scheduler component providing the current version communications channel by dividing, using TDMA, the first portion of spectrum between the legacy version communications using the first modulation technique and the current version communications using the second modulation technique.

In another aspect, an exemplary non-transitory processor readable medium includes processor executable instructions which when executed by a processor cause the processor to perform a method for sharing a communications network between legacy and current versions of a data transfer standard. The method includes: instantiating at least a portion of a scheduler component; facilitating operation of the communications network by using the scheduler component to assign legacy version communications using a first modulation technique to a first portion of spectrum for communications in a first direction to and by using the scheduler component to assign current version communications using a second modulation technique to a second portion of the spectrum for communications in the first direction; and at the scheduler component, obtaining, over a dedicated upstream signaling channel, from a current version cable modem, a request for a current version communications channel in the first direction using the second modulation technique. The method further includes, at the scheduler component, determining that additional bandwidth is required to accommodate the request; responsive to the determining, with the scheduler component, signaling, using a dedicated downstream signaling channel, the current version cable modem to expect the current version communications channel to be provided over the first portion of spectrum using time division multiple access (TDMA); and the scheduler component providing the current version communications channel by dividing, using TDMA, the first portion of spectrum between the legacy version communications using the first modulation technique and the current version communications using the second modulation technique.

In still another aspect, an exemplary apparatus includes a memory; and at least one processor, coupled to the memory, and operative to facilitate sharing a communications network between legacy and current versions of a data transfer standard by: instantiating at least a portion of a scheduler component; facilitating operation of the communications network by using the scheduler component to assign legacy version communications using a first modulation technique to a first portion of spectrum for communications in a first direction to and by using the scheduler component to assign current version communications using a second modulation technique to a second portion of the spectrum for communications in the first direction; at the scheduler component, obtaining, over a dedicated upstream signaling channel, from a current version cable modem, a request for a current version communications channel in the first direction using the second modulation technique; at the scheduler component, determining that additional bandwidth is required to accommodate the request; responsive to the determining, with the scheduler component, signaling, using a dedicated downstream signaling channel, the current version cable modem to expect the current version communications channel to be provided over the first portion of spectrum using time division multiple access (TDMA); and the scheduler component providing the current version communications channel by dividing, using TDMA, the first portion of spectrum between the legacy version communications using the first modulation technique and the current version communications using the second modulation technique.

In a further aspect, an exemplary system includes a virtual cable modem termination system cluster including a legacy version virtual cable modem termination system, a current version virtual cable modem termination system, and a scheduler component coupled to the legacy version virtual cable modem termination system and the current version virtual cable modem termination system; a plurality of legacy version cable modems; a plurality of current version cable modems; and a hybrid fiber-coaxial (HFC) communications network coupling the virtual cable modem termination system cluster with the plurality of legacy version cable modems and the plurality of current version cable modems. The legacy version virtual cable modem termination system and the plurality of legacy version cable modems are configured in accordance with a legacy version of a data transfer standard. The current version virtual cable modem termination system and the plurality of current version cable modems are configured in accordance with a current version of the data transfer standard. The scheduler component is configured to: operate the communications network by assigning legacy version communications using a first modulation technique to a first portion of spectrum for communications in a first direction and by assigning current version communications using a second modulation technique to a second portion of the spectrum for communications in the first direction; obtain, over a dedicated upstream signaling channel of the hybrid fiber-coaxial (HFC) communications network, from a given one of the current version cable modems, a request for a current version communications channel in the first direction using the second modulation technique; determine that additional bandwidth is required to accommodate the request; responsive to the determining, signal, using a dedicated downstream signaling channel of the hybrid fiber-coaxial (HFC) communications network, the given one of the current version cable modems to expect the current version communications channel to be provided over the first portion of spectrum using time division multiple access (TDMA); and provide the current version communications channel by dividing, using TDMA, the first portion of spectrum between the legacy version communications using the first modulation technique and the current version communications using the second modulation technique.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a non-transitory machine-readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus including a memory and at least one processor that is coupled to the memory and operative to perform, or facilitate performance of, exemplary method steps (or a system wherein one or more such apparatuses are networked together, optionally with one or more other components). Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
a plurality of control channels for DOCSIS systems that serve to significantly reduce the time to, for example, bring cable modems online, implement configuration changes and the like;
a next generation scheduler that performs dynamic, fast uplink grant processes in real time by using, for example, an AI-driven scheduling mechanism, thereby improving the technological process of operating a communications network;
enablement of time-division orthogonal frequency division multiple access (OFDMA) to increase efficiency and conserve power when there is no traffic to transmit; and
enabling full OFDMA block for each cable modem in the downstream direction using time-division. OFDMA can transmit data only on the frequency resources needed to send data. This is more energy efficient as compared to legacy OFDM which transmit in downstream all the time at full power which consumes more energy.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIGS. 8A-8B illustrate the bandwidth distribution of a DOCSIS 5.0 system in the downstream (DS) and the upstream (US) OFDMA allocation, as well as the implantation of signaling channels therein, in accordance with exemplary embodiments;

FIG. 9 is a high-level diagram illustrating the coexistence of a DOCSIS 5.0 system with a legacy DOCSIS system, in accordance with exemplary embodiments; and

FIG. 10 is a block diagram of an exemplary coexistence element (CE), in accordance with aspects of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present disclosure will be described herein in the context of apparatus, systems, and methods for electronic devices, networking and network management. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

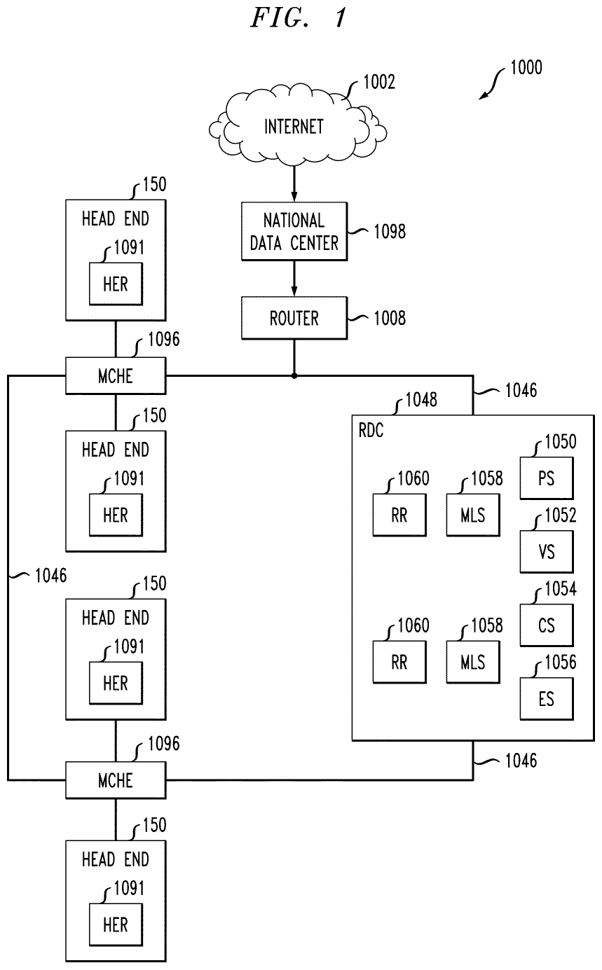

Thus, purely by way of example and not limitation, a description will be provided of a cable multi-service operator (MSO) providing data services as well as entertainment services, as an example environment in which aspects of the invention could be employed, it being understood that aspects of the invention could be employed in many different network environments, and that an MSO is a non-limiting example of an internet service provider (ISP). FIG. 1 shows an exemplary system 1000, according to an aspect of the invention. System 1000 includes a regional data center (RDC) 1048 coupled to several Market Center Head Ends (MCHEs) 1096; each MCHE 1096 is in turn coupled to one or more divisions, represented by division head ends (HEs) 150. In a non-limiting example, the MCHEs are coupled to the RDC 1048 via a network of switches and routers. One suitable example of network 1046 is a dense wavelength division multiplex (DWDM) network. The MCHEs can be employed, for example, for large metropolitan area(s). In addition, the MCHE is connected to localized HEs 150 via high-speed routers 1091 (“HER”=head end router) and a suitable network, which could, for example, also utilize DWDM technology. Elements 1048, 1096 on network 1046 may be operated, for example, by or on behalf of a cable MSO, and may be interconnected with a global system of interconnected computer networks that use the standardized Internet Protocol Suite (TCP/IP) (transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, California, USA.

Head end routers 1091 are omitted from figures below to avoid clutter, and not all switches, routers, etc. associated with network 1046 are shown, also to avoid clutter.

RDC 1048 may include one or more provisioning servers (PS) 1050, one or more Video Servers (VS) 1052, one or more content servers (CS) 1054, and one or more e-mail servers(ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends (local and/or market center) and/or regional data centers. For example, such an NDC might include one or more VOD servers; switched digital video (SDV) functionality; gateways to obtain content (e.g., program content) from various sources including cable feeds and/or satellite; and so on.

In some cases, there may be more than one national data center 1098 (e.g., two) to provide redundancy. There can be multiple regional data centers 1048. In some cases, MCHEs could be omitted and the local head ends 150 coupled directly to the RDC 1048.

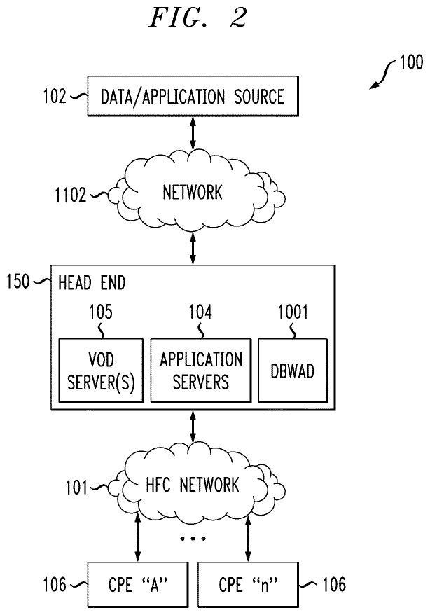

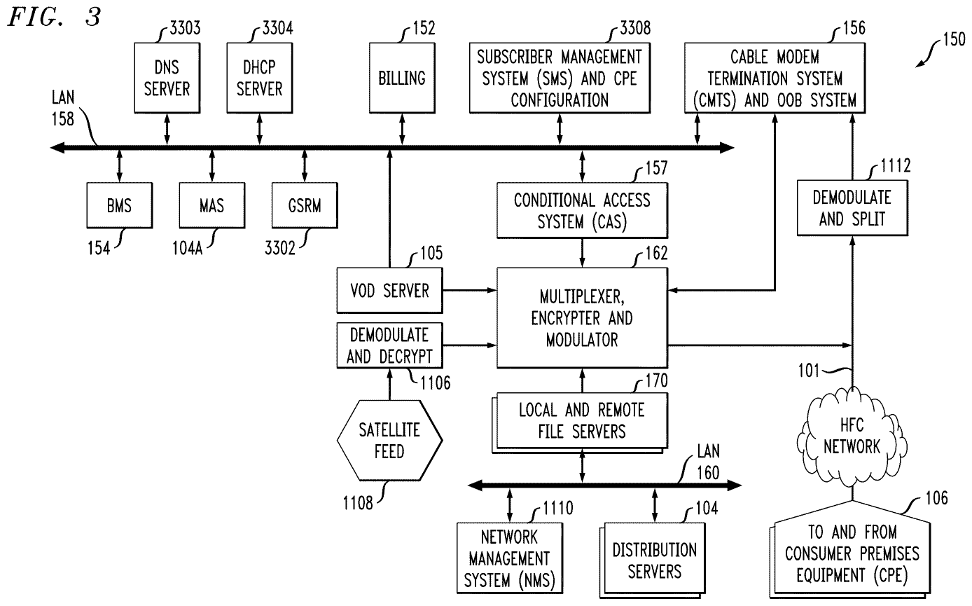

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (iv) consumer premises equipment or customer premises equipment (CPE) 106. The distribution server(s) 104, VOD servers 105 and CPE(s) 106 are connected via a bearer (e.g., HFC) network 101. Servers 104 and 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistently with embodiments of the invention. For example, the head-end architecture of FIG. 3 (described in greater detail below) may be used.

It should be noted that the exemplary CPE 106 is an integrated solution including a cable modem (e.g., DOCSIS) and one or more wireless routers. Other embodiments could employ a two-box solution; i.e., separate cable modem and routers suitably interconnected, which nevertheless, when interconnected, can provide equivalent functionality. Furthermore, FTTH networks can employ Service ONUs (S-ONUs; ONU=optical network unit) as CPE, as discussed elsewhere herein.

The data/application origination point 102 comprises any medium that allows data and/or applications (such as a VOD-based or “Watch TV” application) to be transferred to a distribution server 104, for example, over network 1102. This can include for example a third-party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

The CPE 106 includes any equipment in the “customers'premises” (or other appropriate locations) that can be accessed by the relevant upstream network components. Non-limiting examples of relevant upstream network components, in the context of the HFC network, include a distribution server 104 or a cable modem termination system 156 (discussed below with regard to FIG. 3). The skilled artisan will be familiar with other relevant upstream network components for other kinds of networks (e.g., FTTH) as discussed herein. Non-limiting examples of CPE are set-top boxes, high-speed cable modems, and Advanced Wireless Gateways (AWGs) for providing high bandwidth Internet access in premises such as homes and businesses.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistently with the invention. It will also be appreciated that the head-end configuration depicted in FIG. 3 is high-level, conceptual architecture and that each multi-service operator (MSO) may have multiple head-ends deployed using custom architectures.

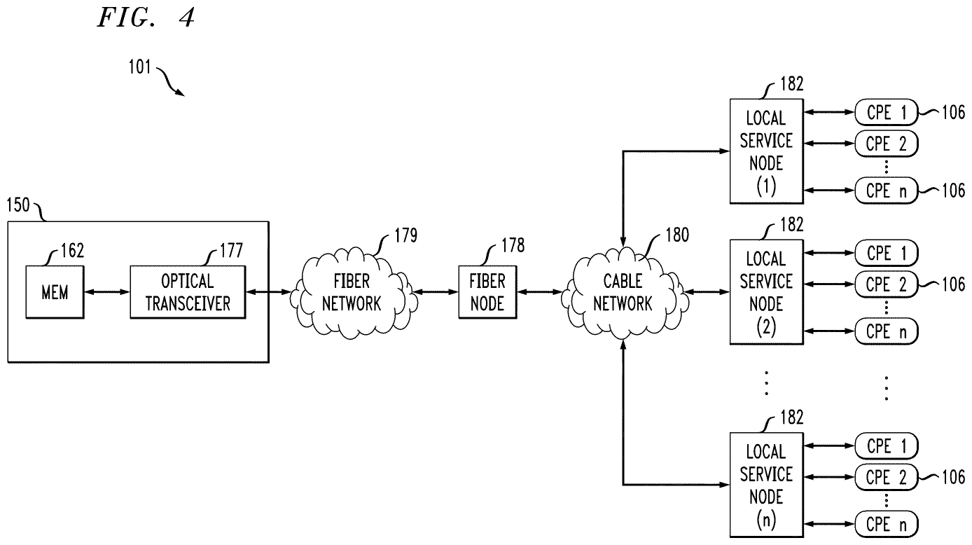

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., audio, video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville CO 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. HFC systems using DOCSIS to transmit data are one non-limiting exemplary application context for one or more embodiments. However, one or more embodiments are applicable to a variety of different kinds of networks.

It is also worth noting that the use of DOCSIS Provisioning of EPON (Ethernet over Passive Optical Network) or “DPoE” (Specifications available from CableLabs, Louisville, CO, USA) enables the transmission of high-speed data over PONs using DOCSIS back-office systems and processes.

It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more Dynamic Host Configuration Protocol (DHCP) server(s) 3304 can also be located where shown or in different locations.

It should be noted that the exemplary architecture in FIG. 3 shows a traditional location for the CMTS 156 in a head end. As will be appreciated by the skilled artisan, CMTS functionality can be moved down closer to the customers or up to a national or regional data center or can be dispersed into one or more locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network 179 to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number n of CPE 106 per node 182 may be different than the number n of nodes 182, and that different nodes may service different numbers n of CPE.

Certain additional aspects of video or other content delivery will now be discussed. It should be understood that embodiments of the invention have broad applicability to a variety of different types of networks. Some embodiments relate to TCP/IP network connectivity for delivery of messages and/or content. Again, delivery of data over a video (or other) content network is but one non-limiting example of a context where one or more embodiments could be implemented. US Patent Publication 2003-0056217 of Paul D. Brooks, entitled “Technique for Effectively Providing Program Material in a Cable Television System,” the complete disclosure of which is expressly incorporated herein by reference in its entirety for all purposes, describes one exemplary broadcast switched digital architecture, although it will be recognized by those of ordinary skill that other approaches and architectures may be substituted. In a cable television system in accordance with the Brooks invention, program materials are made available to subscribers in a neighborhood on an as-needed basis. Specifically, when a subscriber at a set-top terminal selects a program channel to watch, the selection request is transmitted to a head end of the system. In response to such a request, a controller in the head end determines whether the material of the selected program channel has been made available to the neighborhood. If it has been made available, the controller identifies to the set-top terminal the carrier which is carrying the requested program material, and to which the set-top terminal tunes to obtain the requested program material. Otherwise, the controller assigns an unused carrier to carry the requested program material, and informs the set-top terminal of the identity of the newly assigned carrier. The controller also retires those carriers assigned for the program channels which are no longer watched by the subscribers in the neighborhood. Note that reference is made herein, for brevity, to features of the “Brooks invention” it should be understood that no inference should be drawn that such features are necessarily present in all claimed embodiments of Brooks. The Brooks invention is directed to a technique for utilizing limited network bandwidth to distribute program materials to subscribers in a community access television (CATV) system. In accordance with the Brooks invention, the CATV system makes available to subscribers selected program channels, as opposed to all of the program channels furnished by the system as in prior art. In the Brooks CATV system, the program channels are provided on an as needed basis, and are selected to serve the subscribers in the same neighborhood requesting those channels.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference in its entirety for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference in its entirety for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference in its entirety for all purposes.

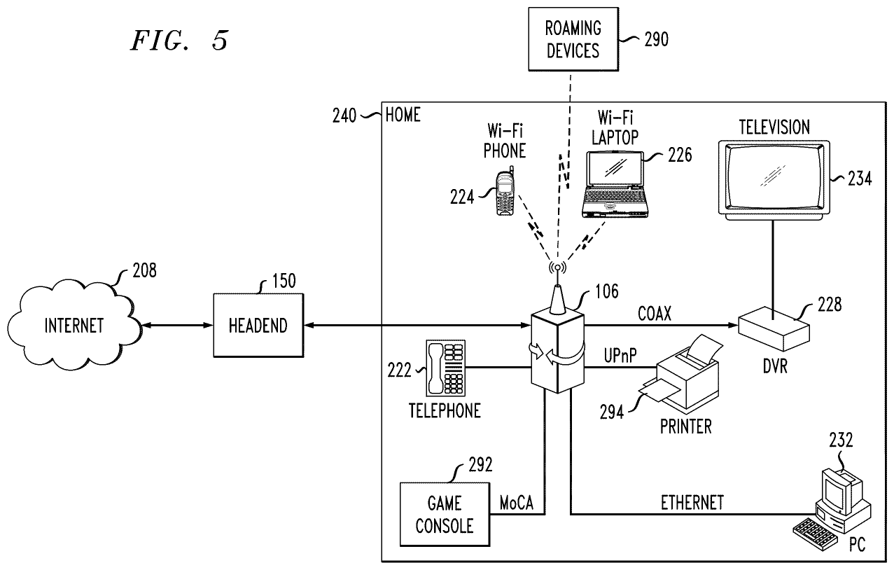

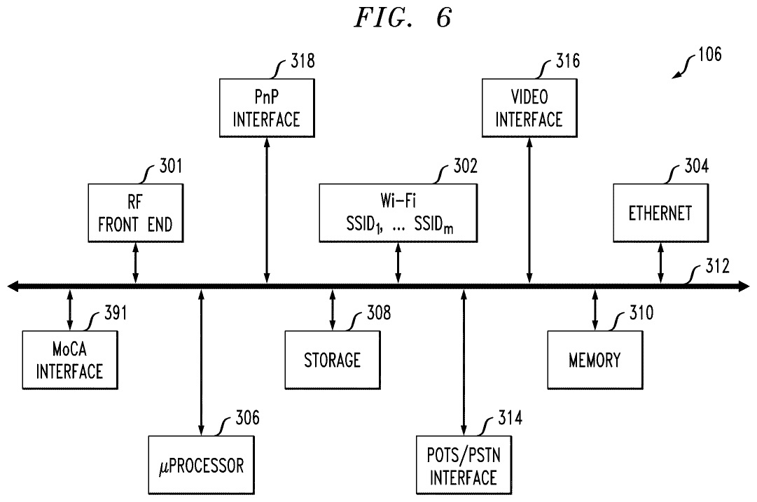

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like.

CPE 106 includes an advanced wireless gateway which connects to a head end 150 or other hub of a network, such as a video content network of an MSO or the like. The head end is coupled also to an internet (e.g., the Internet) 208 which is located externally to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example, over a universal plug and play (UPnP) interface, and/or a game console 292; for example, over a multimedia over coax alliance (MoCA) interface.

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, or other device. CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random-access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6-as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

It should be noted that some embodiments provide a cloud-based user interface, wherein CPE 106 accesses a user interface on a server in the cloud, such as in NDC 1098.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as, for example, packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g., the Wi-Fi interface 302, Ethernet interface 304 or plug-and-play (PnP) interface 318.

Additionally, the RF front end 301 modulates, encrypts/multiplexes as required, and transmits digital information for receipt by upstream entities such as the CMTS or a network server. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB 2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g., Internet protocol television (IPTV) devices, PCs, laptops, etc., as well as by roaming devices 290. In addition, the CPE 106 can be remotely managed (such as from the head end 150, or another remote network agent) to support appropriate IP services. Some embodiments could utilize a cloud-based user interface, wherein CPE 106 accesses a user interface on a server in the cloud, such as in NDC 1098.

In some instances, the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network. Yet again, it should be noted that some embodiments could employ a cloud-based user interface, wherein CPE 106 accesses a user interface on a server in the cloud, such as in NDC 1098. The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

In addition to “broadcast” content (e.g., video programming), the systems of FIGS. 1-6 can, if desired, also deliver Internet data services using the Internet protocol (IP), although other protocols and transport mechanisms of the type well known in the digital communication art may be substituted. In the systems of FIGS. 1-6, the IP packets are typically transmitted on RF channels that are different that the RF channels used for the broadcast video and audio programming, although this is not a requirement. The CPE 106 are each configured to monitor the particular assigned RF channel (such as via a port or socket ID/address, or other such mechanism) for IP packets intended for the subscriber premises/address that they serve. Furthermore, one or more embodiments could be adapted to situations where a cable/fiber broadband operator provides wired broad band data connectivity but does not provide QAM-based broadcast video.

In one or more embodiments, a plurality of control channels are incorporated into a DOCSIS system to significantly reduce the time to, for example, bring cable modems online, implement configuration changes, and the like. Exemplary embodiments enable time-division orthogonal frequency-division multiplexing (OFDM) to increase efficiency and conserve power (e.g., when there is no traffic to transmit).

### Conventional Frequency Allocations

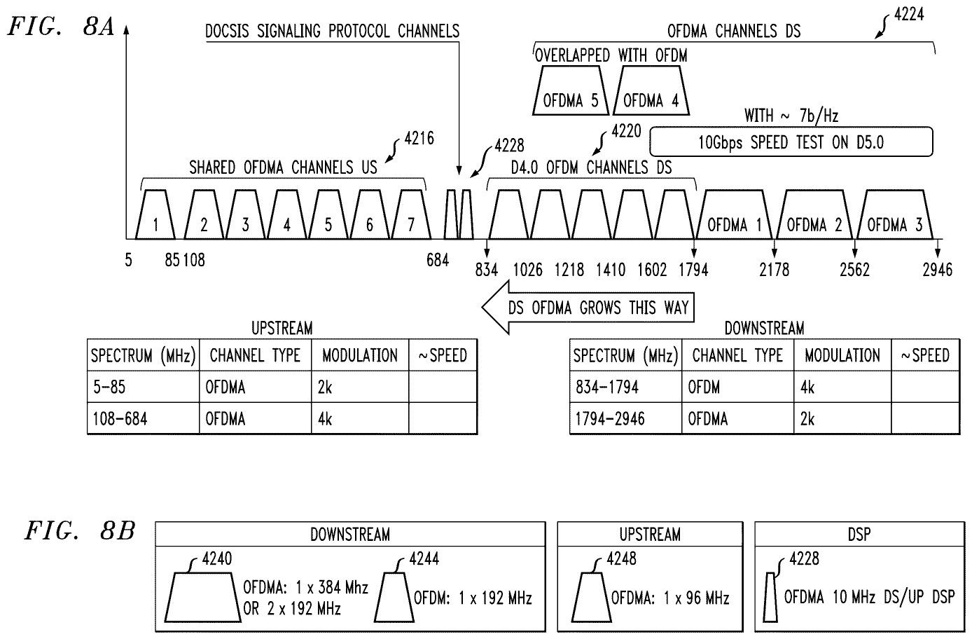

In the downstream direction, conventional internet service providers (ISPs) use OFDM in legacy networks at bandwidths from 834 MHz to 1,798 MHz or from 396 MHz to 1,798 MHz (as per the operators' requirements). In some instances, as seen in FIG. 8A, discussed in more detail below, upstream traffic can go up to 684 MHz and downstream traffic can start from 834 MHz. With OFDM, either the entire downstream spectrum is allocated to one cable modem at a time or is allocated to be shared by all compatible cable modems in a broadcast transmit manner as explained above.

In exemplary embodiments, in the upstream direction, spectrum is limited to a bandwidth of 684 MHz to ensure that, given the signal attenuation over the coaxial cable, the upstream signal can reach the line extender/trunk amplifiers and the node for upstream amplification. The value of 684 MHz is a “sweet spot” that avoids the need for heavy amplification in the cable modem (CM) as well as in the upstream amplifiers, and without the need of any amplifiers spacing in the coaxial plant. This is based on a trade-off to maintain network efficiency, and to ensure compatibility with existing design and amplifier spacing, which optimizes the balance between the downstream and the upstream bandwidth. The use of bandwidth above 684 MHz in the upstream direction can require significant re-engineering of the cable network. This is currently not economically viable, and there are certain other network limitations, including limitations of the home networking equipment (such as in-home amplifiers, splitters, cable modems, and the like), that impact the viability.

### Future Considerations and Requirements

Legacy networks can use OFDM in the downstream direction (up to 1,798 MHz) and next generation DOCSIS can use orthogonal frequency-division multiple access (OFDMA) in the downstream direction for up to 3 GHz or higher. In the future, DOCSIS systems will be able to use OFDMA in both the downstream and upstream directions. In one or more embodiments, the new OFDMA is for the downstream only. Legacy DOCSIS is already using OFDMA in the upstream direction up to 684 MHz and the same spectrum can be leveraged for the Next generation DOCSIS. In one or more embodiments, the next generation scheduler helps to determine the frequency resources available to use for legacy and next generation traffic requirements.

Going beyond a frequency of 3,714 MHz in the downstream direction can have other challenges, such as total composite power (TCP). In addition, there are many other components in the coaxial network that may not allow data transmission above a frequency 3,714 MHz. This potentially means that a complete network upgrade would be required, which may not be economically viable. Adapting OFDMA in the downstream direction can allow longer network life, given that the adaptation will allow higher spectral and energy efficiency.

Moreover, spectrum from a frequency of 834 MHz to 1,798 MHz will be shared by both legacy networks (e.g., up to DOCSIS 4.0, also referred to herein by the shorthand D4) and next generation DOCSIS networks in the downstream direction, where a legacy network will be using OFDM and next generation DOCSIS will be using OFDMA.

Next Generation scheduler and DOCSIS signaling protocol (DSP) channels

A scheduler is a mechanism that assigns network resources, such as bandwidth capacity, to a user. A typical system has a bandwidth capacity; the capacity is a limited resource. Multiple users subscribe to the system and request resources as necessary. For example, a DOCSIS system may have a bandwidth capacity of 10 Gbps. The system may have 100 users that have registered to use the bandwidth of the system. The system delivers the bandwidth over a shared HFC plant. Since the HFC plant is shared, the scheduler orchestrates the system to deliver the bandwidth to the requesting user. The system typically does this by enabling one or more bandwidth channels of a specified capacity for a specified duration of time, and informing the user of the assigned bandwidth channels and when they are assigned for use by the user.

The skilled artisan will be familiar with the Converged Cable Access Platform (CCAP), the concept of a remote physical (“PHY”) device (RPD), the concept of a Remote MACPHY Device (RMD), and with the relevant standards, such as the existing “Remote-Phy” standards, including Data-Over-Cable Service Interface Specifications DCA-MHAv2, Modular Headend Architecture v2 Technical Report, CM-TR-MHAv2-V01-150615, Cable Television Laboratories, Inc. 2014-2015, Jun. 15, 2015, and Data-Over-Cable Service Interface Specifications DCA, Distributed CCAP Architectures Overview Technical Report, CM-TR-DCA-V01-150908, Cable Television Laboratories, Inc. 2015, Sep. 8, 2015, both of which are hereby expressly incorporated herein by reference in their entireties for all purposes.

Currently, DOCSIS includes a scheduler component that is used to allocate bandwidth to the cable modems on the network. As data comes in to the scheduler, the scheduler examines the data and determines where the data needs to go; then, the scheduler broadcasts the data out over the cable, allocating the data in terms of frequency (channel) and time. Furthermore in this regard, DOCSIS has a number of channels; the scheduler picks the channel it wants to use and then it identifies a particular time for the data to be transmitted. Then, the cable modem is told what part of the spectrum (frequency) to use, and what time to look at that portion of the spectrum to retrieve the data. A similar sort of thing happens in the opposite (upstream) direction, except that in the upstream direction, the modem first has to contend, and then ask for a time slot to be granted (in one or more embodiments, the modem requests bandwidth using a contention mechanism-the scheduler then informs the successful modem what channel and timeslot it can use to transmit its data in the upstream direction). Then, the system tells the modem what channel and time slot to use. Thus, in the upstream direction, there is an additional contention grant mechanism.

In the downstream direction, resources are allocated based on channel and on time. The current DOCSIS network has amplifiers and passives that were designed to operate in a certain frequency spectrum. Some current HFC plants have been updated to operate at 1 GHz. In some instances, the envelope can be further pushed to operate at 1.2 GHz, with the understanding that the higher frequencies will be subject to roll off, and thus, there will be loss of performance at the top end.

As used herein, including the claims, a cable modem termination system/CMTS should be understood to cover a legacy cable modem termination system, a virtualized cable modem termination system (vCMTS) as used in the DOCSIS DAA (Distributed Access Architecture) system, an RPD/vCore implementation, and the like; specific reference to a vCMTS is intended to refer to a virtualized cable modem termination system.

As would be appreciated by the skilled artisan, the scheduler is a component within the DOCSIS specification, and in general, it can be implemented in hardware or software. Older scheduler implementations have typically been done in hardware. Given the teachings herein, aspects of the invention can be readily implemented by adapting an existing scheduler, developing a new scheduler, or a combination of both. One or more embodiments can advantageously be implemented using a software-implemented scheduler. The vCMTS scheduler is software-based. Typically, the vCMTS has a scheduler function built into it. In other words, the vCMTS also has other management and configuration capabilities in addition to the scheduler. For the avoidance of doubt, the current state-of-the-art vCMTS scheduler is software-based, and, given the teachings herein, one or more embodiments of the invention can advantageously be implemented in software by the skilled artisan, by adapting a known scheduler to implement aspects of the invention.

As noted elsewhere, as used herein, including the claims, a cable modem termination system should be broadly understood to include both legacy iCMTS architectures and DAA (Distributed Access Architecture) systems. In DAA, the combination of a vCMTS and RPD or the combination of a MAC Manager and Remote MACPHY Device (RMD) has the equivalent function of a CMTS. Refer also to the discussion of the vCore/RPD alternative just below, since the vCMTS is a component of the vCore. In the case of the MAC Manager/RMD, the overall system functionality is equivalent, but the location of the MAC function is moved to the RMD. element 2095 should be broadly understood as representative of both legacy and virtual implementations.

RPD/vCore alternative: Another non-limiting exemplary aspect will now be discussed (note that the vCMTS is a component of the vCore). In this regard, MAC and PHY layers are concepts familiar to the ordinary skilled worker; generally, the MAC layer controls the timing of signals to be sent from or received by equipment, while the PHY layer generates or receives the actual signals on the physical connection. The skilled artisan will also be familiar with the Converged Cable Access Platform (CCAP), the concept of a remote physical device (RPD), and with the existing “Remote-Phy” standards, including Data-Over-Cable Service Interface Specifications DCA-MHAv2, Modular Headend Architecture v2 Technical Report, CM-TR-MHAv2-V01-150615, Cable Television Laboratories, Inc. 2014-2015, Jun. 15, 2015, and Data-Over-Cable Service Interface Specifications DCA, Distributed CCAP Architectures Overview Technical Report, CM-TR-DCA-V01-150908, Cable Television Laboratories, Inc. 2015, Sep. 8, 2015, both of which are hereby expressly incorporated herein by reference in their entireties for all purposes. The Remote PHY technology allows for an integrated CCAP to be separated into two components: the CCAP Core and the Remote PHY Device (RPD). One of the common locations for an RPD is the optical node device that is located at the junction of the fiber and coax plants, while the CCAP Core stays at the headend. A CCAP core can control and setup data paths with multiple RPDs situated in multiple fiber nodes. The Remote PHY technology uses pseudowires between a CCAP Core and a set of RPDs. The CCAP Core contains both a CMTS Core for supporting DOCSIS data transport and an Edge QAM Core for supporting video transport. The CMTS Core contains the DOCSIS MAC (signaling functions, downstream and upstream bandwidth scheduling, and DOCSIS framing) and the upper layer protocols. Remote PHY supports both DOCSIS 3.0, 3.1 & 4.0 Specifications. The EQAM Core contains known video processing functions. The skilled artisan will also be familiar with the virtual core (vCore) concept. As will be appreciated by the skilled artisan given the teachings herein, embodiments of the invention can utilize RPD/vCore functionality.

It is worth noting that the skilled artisan will be familiar with DOCSIS management messaging for a CMTS and/or scheduler to retrieve information from a modem.

In exemplary embodiments, a next generation scheduler performs dynamic, fast uplink grant processes in real time by using, for example, an AI-driven scheduling mechanism. Next generation CMs will use only OFDMA in the downstream direction. If a next generation CM requires more bandwidth, the scheduler can assess, in real-time, the spectrum availability, and if necessary, can allocate additional resources to OFDMA from the OFDM spectrum that is allocated for legacy CM devices in the downstream direction. This can be done, for example, by using a time-division strategy. In exemplary embodiments, the next generation scheduler will only allow next generation DOCSIS systems to use spectrum below 1,798 MHz when there is a requirement, such as, for example, a speed test (see, e.g., 10 Gbps speed test on D5.0 in FIG. 8A). If there is a need to go beyond a frequency of 10 GHz or 15 GHz, the spectrum in the downstream direction from a legacy network (which is reserved for OFDMA traffic) can be used. In one or more embodiments, a next generation scheduler in accordance with aspects of the invention will only allow next generation DOCSIS to use spectrum below 1798 MHz when there is a requirement such as, for example, a speed test beyond DOCSIS 4.0 (e.g., 15 Gbps, 20 Gbps, . . . ), and any other use case that requires speed higher than 10 Gbps. Again, for the avoidance of doubt, a speed test is a non-limiting example of a use case requiring a speed higher than 10 Gbps.

Assuming the spectrum allocation extends up to a frequency of 2,946 MHz, next generation cable modems (CMs) will be utilizing frequencies starting from 1,798 MHz and above. Over time, as legacy CMs are phased out and replaced by the next generation CMs, the usable spectrum can expand in the opposite direction, from 1,794 MHz to 684 MHz. OFDMA channels offer significant flexibility, with channel width ranging from as narrow as 6.4 MHz to as wide as 384 MHz. In exemplary embodiments, 384 MHz is utilized since it can provide a better error code algorithm.

FIGS. 8A-8B illustrate the bandwidth distribution of a DOCSIS 5.0 (also referred to herein by the shorthand D5) system in the downstream (DS) and the upstream (US) OFDMA allocation, as well as DSP channels in accordance with aspects of the invention. As illustrated in FIG. 8A, shared OFDMA channels upstream (US) 4216 occupy the lower bandwidth from, for example, 5 MHz to 684 MHz in the upstream direction. DOCSIS 4.0 OFDM channels downstream (DS) 4220 occupy the middle bandwidth from, for example, 834 MHz to 2,946 MHz in the downstream direction. OFDMA channels downstream (DS) 4224, such as OFDMA1, . . . , OFDMA3, occupy the upper bandwidth. In exemplary embodiments, DOCSIS signaling protocol channels 4228 are incorporated between the shared OFDMA channels US 4216 and the DOCSIS 4.0 OFDM channels DS 4220 and are configured as 10 MHz OFDMA DS/US channels. As illustrated in FIG. 8B, in the downstream direction, each OFDMA channel includes 1×384 MHz or 2×192 MHz channel(s) 4240 and each OFDM channel includes 1×192 MHz channel 4244. In the upstream direction, each OFDMA channel 4248 includes 1×96 MHz channel.

Note that non-limiting examples are presented in the context of D4 and D5; however, embodiments are broadly applicable to the sharing of a communications network between legacy (by way of example and not limitation, DOCSIS 3.0, 3.1, and/or 4.0) and current (by way of example and not limitation, Next Generation DOCSIS such as DOCSIS 5.0) versions of a data transfer standard (by way of example and not limitation, DOCSIS). “Current” in this context should simply be understood as a version of the standard that is updated as compared to the legacy version(s).

In one or more embodiments, to make a next generation scheduler more effective, the intelligence can be moved into the vCMTS core. This will utilize, for example, dedicated channels 4228, referred to as DOCSIS Signaling Protocols (DSP) channels herein, for efficient and real-time communication. Historically, in the DOCSIS world, it has always been considered that cable modems need to be backward compatible. Similarly, CMTS have always been considered as needing backward compatibility. In one or more embodiments, the cable modem does not need to be backward compatible, because of moving the intelligence. Since the network is no longer a legacy network-the PHYs (physical devices) move into the node and the vCMTS core can allocate resources based on the CM. The CMTS can be backward-compatible, e.g., next generation DOCSIS 5.0 and legacy DOCSIS, but in one or more embodiments, the next generation CM will only be compatible with next generation CMTS. To enhance efficiency, today, every channel has its own Physical layer Link Channel (PLC), which is similar to a control channel in the DOCSIS world. To enhance efficiency and make the scheduler work more effectively, one or more embodiments introduce two DSP channels 4228, one for the downstream and one for the upstream. In exemplary embodiments, each DSP channel 4228 is configured as a 10 MHz wide channel that is allocated for management and control traffic only. The DSP channels 4228 can be placed between 684 MHz and 834 MHz, for example. In the upstream direction, the scheduler can also help allocate bandwidth.

In exemplary embodiments, each DSP channel 4228 is allocated for management and control traffic, and is configured as a 10 MHz OFDMA channel corresponding to one of the directions, downstream or upstream. The DSP channels 4228 can be placed between 684 MHz and 834 MHz or, for the upstream direction, below 684 MHz and, for the downstream direction, above 1,218 MHz. Note that the space between 684 MHz and 834 MHz is currently a guard band, but should be sufficiently wide to fit the DSP channels. A next generation scheduler will enable the use of the same OFDMA spectrum, up to 684 MHz in the upstream direction for both legacy and next generation DOCSIS systems. The specific location of the DSP channels is not necessarily critical as long as suitable dedicated channels are provided.

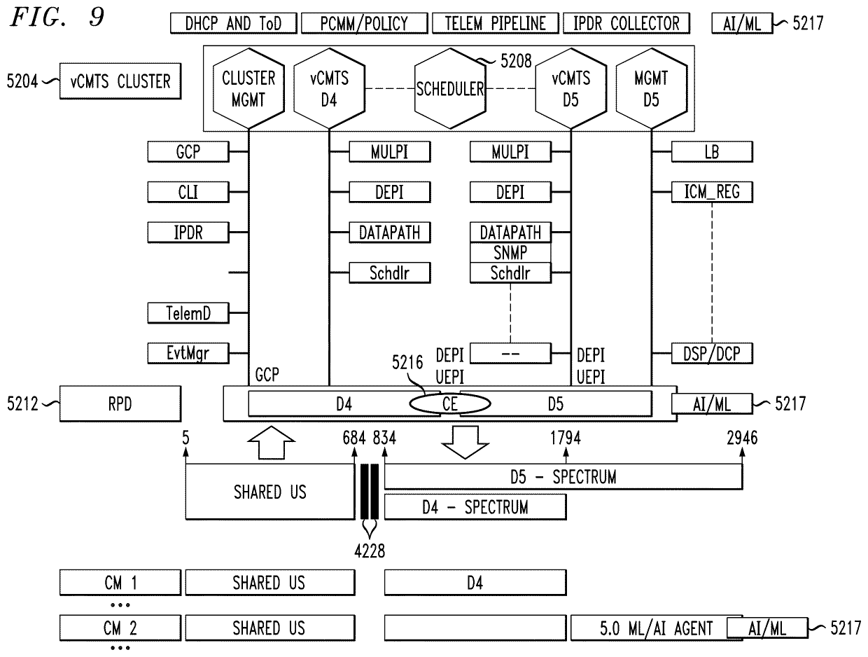

FIG. 9 is a high-level diagram illustrating the coexistence of a DOCSIS 5.0 system with a legacy DOCSIS system, in accordance with exemplary embodiments. A coexistence (CE) module 5216 decides where to send DOCSIS 5.0 traffic: to a next generation cable modem or a legacy cable modem. The intelligence resides in the core and uses the DSP channels 4228 for signaling. Artificial intelligence (AI) interacts with a scheduler 5208 via the DSP channels 4228 and gathers historical data, performs annotations by a subject matter expert, deals with network congestion, and the like.

In one or more embodiments, Next Generation scheduler 5208 enables the use of the same OFDMA spectrum up to 684 MHz in the upstream direction for both legacy and next generation DOCSIS. Consider, when adding downstream, what will happen to the upstream? Regarding upstream, there is not an easy path, and it is not easy to expand OFDMA that is already in use. In one or more embodiments, the scheduler 5208 in a next generation DOCSIS CMTS can help allocate resources for both legacy and next generation CMs. One or more embodiments keep D5/next generation limited functionality in the cable modem and handle more functionality in the core, with the use of the separate signaling channels 4228 for the controller to communicate with the CM using the AI/ML agent 5217 or the like.

One or more embodiments include the two new channels 4228. Consider the AI/ML agent 5217 and the two new channels 4228, one for downstream and one for upstream, that do not exist in the prior art. The two new channels 4228 can be anywhere in the spectrum. In one or more embodiments, they are dedicated and can leverage the AI/ML agent 5217 for a quick turnup of a next generation CM without going through extensive scanning (a quick scan can be carried out). Furthermore, in one or more embodiments, all the health-related information can be pushed to the vCMTS core. That is to say, the D5 cable modem (CM2) can use the dedicated channels 4228 to communicate with the vCMTS core (vCMTS D5 and Mgmt D5).

In one or more embodiments, when the intelligence is moved into the vCMTS core, the complexity of the CPE device is reduced for layer 2 tasks and the DOCSIS 5.0 cable modem device is only compatible with a DOCSIS 5.0 CMTS/Remote PHY Device (RPD). Note that vCMTS 5.0 and RPD 5.0 are pre-requisites for the DOCSIS 5.0 cable modem deployment.

In one or more embodiments, configuration issues include:
vCMTS cluster 5204 and RPD 5212 must support backwards compatibility;
the DOCSIS 5.0 cable modem is not backwards compatible;
the DOCSIS 5.0 system uses OFDMA in both the downstream and upstream directions; and
the upstream spectrum is shared between the DOCSIS 5.0 system and the legacy DOCSIS system.

It is noted that the DOCSIS 5.0 cable modem registration process may differ from the legacy cable modem registration process. It is also noted that OFDMA and OFDM can operate on the same frequencies (in the event of a speed test and any other use case that requires speed higher than 10 Gbps—again, for the avoidance of doubt, a speed test is a non-limiting example of a use case requiring a speed higher than 10 Gbps). In exemplary embodiments, artificial intelligence (AI)/machine learning (ML) agent 5217 is used to predict traffic congestion and pre-allocate resources for intelligent load balancing. OFDMA subcarriers are dynamically adjusted for each cable modem based on demand as well as based on signal-to-noise ratio (SNR). In one or more embodiments, AI/ML agent 5217 is separate from the scheduler 5208 but talks to it continuously using the channels 4228. AI/ML agent 5217 provides advantages over SNMP and legacy protocols including leveraging for advanced telemetry. In one or more embodiments, a human subject matter expert (SME) labels historical data on how to allocate channels, deal with congestion, and the like. The model then trains on the labeled historical data and is deployed to carry out inferencing including channel allocation, congestion control, communication with the scheduler using the dedicate channels 4228, and the like.

In FIG. 9, note that elements not specifically discussed are named using nomenclature from the DOCSIS standards that will be familiar to the skilled artisan. Starting from the bottom, note two cable modems CM1 and CM2. Each cable modem uses shared upstream (US) bandwidth. In the downstream (DS) direction, CM1 is D4 and CM2 is D5 and includes AI/ML agent 5217. Considering the RPD 5212, shared US bandwidth is utilized. In the DS direction, note the overlap between D4 and D5. The Cluster Mgmt and vCMTS D4 elements relate to a DOCSIS 4 legacy CMTS port. One or more embodiments make use of virtualization, which provides flexibility. It is possible to have microservices running on the vCMTS cluster 5205. Furthermore, note two other ports for D5; namely, vCMTS D5 and Mgmt D5. Next Generation scheduler 5208 is located between the between DOCSIS 4.0 and DOCSIS 5.0 components of the vCMTS cluster 5204. Traffic from the Cluster Mgmt and vCMTS D4 elements goes through the D4 portion of the RPD 5212 to the D4 cable modem CM1. However, traffic from vCMTS D5 and Mgmt D5 goes through the CE 5216 to the D5 modem CM2. The scheduler 5208 can undertake quick scanning using dedicated channels 4228 to see which frequencies can be allocated to D5.

Considering traffic upstream from D4 CM1 (for provisioning when D4 CM1 comes online): communication is through D4 spectrum to the D4 portion of RPD 5212 to the Cluster Mgmt and vCMTS D4 elements of 5204. D4 can access the DHCP server to obtain the IP address(es) from a TFTP config file.

Considering traffic upstream from D5 CM2 (for provisioning when D5 CM2 comes online): one or more embodiments leverage the dedicated channels 4228 and it is not necessary to go through a scanning process. When D5 CM2 comes online, provisioning traffic goes through the dedicated management channel through the D5 part of the RPD and directly to the D5 POD of the vCMTS (vCMTS D5 and Mgmt D5) to obtain whatever is needed for provisioning.

### Provisioning Considerations

In one or more embodiments, given the teachings herein, the skilled artisan can adapt convention provisioning techniques to implement aspects of the invention.

### Backwards/Forward Compatibility

Historically, backward compatibility requirements for both cable modem termination systems (CMTS) and cable modems (CMs) have imposed constraints that hinder a transition away from legacy protocols. However, shifting intelligence into the core, while restricting backward compatibility requirements to the core alone (and not to the CMs), can enable the adoption of modern protocols, advanced provisioning, and management functions mechanisms. This approach relieves the CM of legacy protocol constraints, thereby promoting innovation and flexibility in network management and provisioning.

### DOCSIS 5.0 Cable Modems/Customer Premises Equipment

It is noted that dynamic host configuration protocol (DHCP) requires little change to implement one or more embodiments, although additional vendor options can be added to support new or different provisioning patterns. It is also noted that trivial file transfer protocol (TFTP) does not have any inherent mechanisms to secure the files or protect content, and that passing things like Simple Network Management Protocol (SNMP) communities in the clear has been a long-standing challenge. One or more embodiments advantageously allow the elimination of SNMP usage, by making a next generation CM device a “dumb” device and moving intelligence into the core so that whenever the CM needs to report, it is reporting to the CORE on its own dedicated channel. The CORE then sends the information further upstream for all connected CMs; e.g., streaming telemetry, health information, and any other pertinent information related to the DOCSIS traffic.

### Provisioning Options

Consider a virtual cable modem termination system (vCMTS) core cluster 5204 as seen in FIG. 9, in accordance with exemplary embodiments. In some instances, when a cable modem (CM) comes online, it communicates with the vCMTS, using DOCSIS signaling. The communication is relayed by the vCMTS to the DHCP server as part of the discovery process. The needed file(s) are then downloaded from a TFTP server or the like to the CM. In one or more embodiments, the DHCP server allocates the Internet protocol (IP) address to the CM.

It is worth noting that in one or more embodiments, there are different PODs for different applications/functions. For example, a vCMTS POD has DOCSIS functions, a management POD has generic control plane (GCP) functions for DOCSIS, and another management POD is provided for management functions associated with a container orchestration platform such as Kubernetes, and so on. A POD can accordingly be a collection of containers implementing DOCSIS processing (excluding the PHY layer) or the like. In this regard, in one or more embodiments, the PHY layer is moved to the remote PHY device and is not part of the vCMTS core function.

Separate things that are containerized could be on a platform, on bare metal equipment that is not in the cloud, or in a container in the cloud, or the like. That is to say, a cloud is a possible location for containers, but they could also be in a data center. Generally, a POD is a concept in the containerization/virtualization world, which can host a function. A vCMTS POD has vCMTS-related functions such as DOCSIS payload functions, management functions, and the like, and there are different PODS for different applications/functions. Every POD will typically have its own functions for the use of that particular application. Embodiments can be utilized with PODS or containers; a non-limiting example is illustrated with PODS. A POD can further “slice” things in containers. For example, in a single vCMTS core, there can be ten PODS for the vCMTS and each POD can be for one, four, or eight nodes, for example, depending on how the slicing is carried out.

Now further considering examples of provisioning, in some cases, the TFTP server also functions as an access control server (ACS). This aspect adds a layer of security with ACS; also, TR369 is used for the file download. After the DOCSIS 5.0 CM2 obtains the initial connectivity and configuration, if it needs to go further north in the network (to the Business Support Systems (BSS) or Operations Support Systems (OSS) to obtain the billing file or configuration, for example), it can do so.

### Exemplary Instantiations of Various Components

Initially, for any components not discussed specifically in this section, the skilled person, given the teachings herein, can adapt known components to implement aspects of the invention.

Scheduler 5208: as discussed elsewhere herein, in a non-limiting example, given the teachings herein, one or more embodiments of the invention can advantageously be implemented in software by the skilled artisan, by adapting a known DOCSIS vCMTS scheduler to implement aspects of the invention including the logic described herein.

AI/ML agent 5217: can be, by way of example and not limitation, a neural network trained to carry out the functionality described herein by training it on data annotated by a human subject matter expert using heuristics appropriate to the application. As noted elsewhere herein, in one or more embodiments, AI/ML agent 5217 implementing aspects of the invention is separate from the scheduler 5208 but communicates with it continuously using the channels 4228. In one or more embodiments, AI/ML agent 5217 implementing aspects of the invention is located in the CM 2 cable modem and will leverage the dedicated upstream and downstream channels 4228. Note that FIG. 9 generally depicts AI/ML 5217 in three locations since the RPD and vCMTS core can have existing AI/ML capability. The skilled artisan will be familiar with various techniques for implementing AI/ML, such as hardware, software on a general purpose or special purpose processor (e.g., array of GPUs), software on a processor with a hardware accelerator, and the like. One or more embodiments employ software running on a processor on CM 2. In some instances, there is an AI engine in CM 2 and the software creates a model that can be run by an AI/ML distributed engine that exists in CM2.

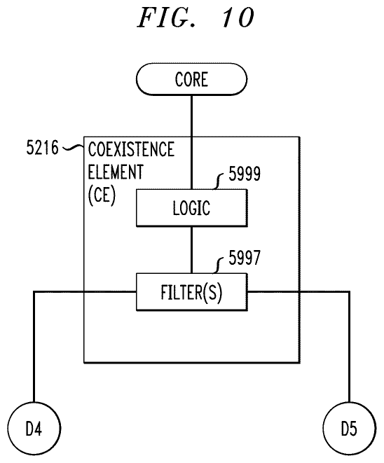

Coexistence (CE) module 5216: Referring now also to FIG. 10, recall that a pertinent aspect of one or more embodiments is moving all the intelligence into the core and leaving the D5 CM “dumb” compared to a D4 CM. Historically, as new DOCSIS versions are introduced, both the vCMTS core and CM need to be backward-compatible. One or more embodiments locate all the intelligence in the core for D5. There will typically be legacy D4 cable modems in the areas where it is desired to add D5 cable modems. The way D5 operates on its own dedicated channels will be different than legacy DOCSIS; accordingly, one or more embodiments provide the coexistence element (CE) 5216 in the RPD. When upgrading the RPD from D4 to D5, the CE helps to route both D5 and legacy traffic. In some instances, the coexistence device 5216 will receive a destination address, and since the core knows whether the address is on the D5 or D4 network, the core can work with the CE 5216 to ensure routing to the correct place. Note the Mgmt D5 POD in the vCMTS cluster 5204 and the connection to DSP (DOCSIS signaling protocol). One or more embodiments add two interfaces to help communicate with the CE 5216 and route the traffic based on the purpose of the traffic. It is worth noting that CE 5216 can be hardware (e.g., digital circuitry) cooperating with software and/or firmware. Currently, in D4, there is a DCP generic control plane that is used for the control plane traffic between the vCMTS core and RPD.

Still considering the coexistence (CE) module 5216, in FIG. 9, traffic intended for the legacy/D4 cable modem CM 1 will use the left-hand path. When adding D5 cable modem CM 2, RPD 5212 needs both D4 and D5 support. Scheduler 5204 defines traffic as meant for D5 and instead of DCP it uses another path. Currently, when the D4 RPD comes online, it uses the GCP path to the D4 vCMTS in the core. Since one or more embodiments introduce a non-backward-compatible CM 2, components (e.g., two) are provided to ensure backward-compatibility in the RPD and vCMTS core, implying that the CE5216 differentiates between D4 and D5. One or more embodiments do not need a new control path between the vCMTS core and the RPD. In some instances, if the frequency is greater than 1.8 GHz, when the co-existence module 5216 detects OFDMA in the downstream then it sends the traffic towards (D5) CM 2. As noted above, the CE 5216 can be hardware (digital circuitry; e.g., an ASIC rather than a general-purpose processor) plus software and/or firmware. In one or more embodiments, because the frequency division multiplexing is being changed for the downstream, aspects of some implementations will be hardware-dependent because the hardware should be: (i) capable of supporting more bandwidth and more channels; and (ii) there is a different modulation access for the downstream. Some instances utilize hardware but a software component decides what traffic goes to D4 and what traffic goes to D5.

Further considering the coexistence (CE) module 5216, in one or more embodiments, a pertinent aspect of the CE 5216 is to couple the D5 RPD to the coaxial plant and to couple the D4 RPD onto the coaxial plant as needed. In general, there will be a frequency division. In one or more embodiments, there is a certain frequency point, above which is OFDMA for D5 and below which is OFDM for D4. The coupling can be implemented, for example, through a series of filters 5997. If the filters are static, you would not necessarily have the dynamic flexibility to shift the frequency point more to the D5 side or D4 side depending on needs. In one or more embodiments, the CE 5216 includes logic 5999 that changes the filter components so that if it is desired to expand D5 because D4 use is being reduced, it is possible to slide the frequency boundary down and apply more spectrum to D5. In one or more embodiments, the software/firmware component (e.g., logic 5999) obtains instructions from the core regarding where to set the boundary (frequency point) to obtain appropriate coupling onto the coaxial cable. Thus, in one or more embodiments, the CE 5216 includes custom digital circuitry, software, and/or firmware implementing logic 5999 to route traffic to D4 or D5 as the case may be and to move the dividing line (frequency point). The different filter banks can be created with discreet components or digitally created through digital signal processor (DSP) functionality; that is to say, filter(s) 5997 can be a series of discrete physical filters with splitter(s), multiplexer(s), switch(es), and the like, or can be implemented with one or more DSPs.

As a general matter, the skilled artisan will be familiar with the synthesis of custom digital circuitry using computer-aided design techniques, hardware description language (HDL) representations, and the like, and given the teachings herein, can implement custom digital circuitry, ASICs, FPGAs, or the like to implement hardware aspects of the invention.

Given the discussion thus far, it will be appreciated that, in general terms, an exemplary method is provided for sharing a communications network between legacy (e.g., DOCSIS 3.0, 3.1, and/or 4.0) and current (e.g., DOCSIS 5.0) versions of a data transfer standard (e.g., DOCSIS). According to an aspect of the invention, the method includes the step of operating the communications network by using a scheduler component such as 5208 to assign legacy version communications using a first modulation technique (e.g., OFDM) to a first portion (e.g. 834 MHz-1794 MHz) of spectrum for communications in a first direction (e.g., downstream) and by using the scheduler component to assign current version communications using a second modulation technique (e.g., OFDMA) to a second portion (e.g., 1794 MHz-2946 MHz) of the spectrum for communications in the first direction. A further step includes, at the scheduler component, obtaining, over a dedicated upstream signaling channel (e.g., the upstream channel of channels 4228), from a current version cable modem CM2, a request for a current version communications channel in the first direction using the second modulation technique.

As an aside, it is worth noting that: (i) in addition to requesting resource(s)/channel(s), D5.0(Next-Gen) cable modem CM2 can use the upstream dedicated channel 4228 to send cable modem health information and/or telemetry data; and (ii) the dedicated channel can be used for D5-CM2 communicates with the scheduler 5208 to determine what can be assigned to D5 and to initiate scheduling via TDMA.

Now continuing, a further step includes, at the scheduler component, determining that additional bandwidth is required to accommodate the request. For example, the scheduler receives the request for a current version communications channel (e.g., next generation/D5), and logic in the scheduler determines that all channels in the conventional current version (e.g., next generation/D5) spectral location are in use.

A still further step includes, responsive to the determining, with the scheduler component, signaling, using a dedicated downstream signaling channel (e.g., downstream channel of the channels 4228), the current version cable modem CM2 to expect the current version communications channel to be provided over the first portion of spectrum using time division multiple access (TDMA).

Yet a further step includes the scheduler component providing the current version communications channel by dividing, using TDMA, the first portion of spectrum between the legacy version communications using the first modulation technique and the current version communications using the second modulation technique (e.g., creating one or more “extra” OFDMA channels such as OFDMA 4 and OFDMA 5 in FIGS. 8A and 8B).

Some embodiments further include sending traffic to the current version cable modem CM2 over the current version communications channel from a current version virtual cable modem termination system (e.g., vCMTS D5) via a remote physical (“PHY”) device (RPD) 5212.

Some embodiments further include directing the traffic to the current version cable modem using a coexistence (CE) module 5216 in the remote physical (“PHY”) device (RPD) 5212. Furthermore in this regard, in one or more embodiments, coexistence (CE) module 5216 decides where to send DOCSIS 5.0 traffic: to a next generation cable modem or a legacy cable modem. That is to say, the RPD can have a module 5216 that can understand whether traffic is meant for D4 or D5, as discussed above. Looking again at FIG. 9, whenever the D4 frequency range is to be used for D5, use the CE 5216 and scheduler/core functionality. A pertinent reason for including the coexistence module 5216 is to distinguish traffic between legacy and next generation DOCSIS. In one or more embodiments, because of moving all intelligence to the vCMTS D5, it will be appropriate to utilize coexistence module 5216 in the RPD 5212 that can direct the traffic to the relevant frequency and cable modem. In one or more embodiments, the coexistence module 5216 will only understand the next generation DOCSIS traffic as the legacy traffic will continue utilizing prior art techniques.

In a non-limiting example, the data transfer standard is DOCSIS; the legacy version of the data transfer standard is at least one of DOCSIS 3.0, DOCSIS 3.1, and DOCSIS 4.0; the current version of the data transfer standard is DOCSIS 5.0; the first modulation technique is orthogonal frequency-division multiplexing (OFDM); the second modulation technique is orthogonal frequency division multiple access (OFDMA); and the communications network is a hybrid fiber-coaxial (HFC) communications network such as network 101.

In some instances, the method is carried out during upgrade of the network from the legacy to the current versions of the data transfer standard. Typically, the network is connected to a plurality of cable modems including: the current version cable modem CM 2, a plurality of additional current version cable modems (more instances of CM2 as suggested by the ellipses in FIG. 9), and a plurality of legacy version cable modems (multiple instances of CM1 as suggested by the ellipses in FIG. 9). The method can then further include expanding the second portion of the spectrum with respect to the first portion of the spectrum as the number of legacy version cable modems in the plurality of legacy version cable modems decreases during the upgrade (see “DS OFDMA Grows this Way” in FIG. 8A). Note, however, that aspects of the invention are not limited to the use case of an upgrade. Expansion and contraction of the spectrum of the current network (e.g., D5) can, for example, be carried out to maximize overall traffic transmitted by the combined legacy (e.g., D4) and current (e.g., D5) networks depending on the capabilities of the cable modems (CMs) and the like. For example, if the current network has CMs on it that can also be supported by the legacy network, but due to traffic conditions the current network is congested and the legacy network is not, it may be beneficial to shift the boundary between the two networks up to force some traffic from the current network to be carried by an under-utilized legacy network. The opposite could also be true. Some legacy CMs will not have capabilities of current modems, so the traffic flow through them should also be taken into consideration by the scheduler working with the CE device 5216. Thus, one or more embodiments can also be used to maximize the traffic carrying capacity of the two networks by shifting the boundary of the CE in communication with the scheduler.

As noted, in some instances, the network is connected to a plurality of cable modems including: the current version cable modem, a plurality of additional current version cable modems, and a plurality of legacy version cable modems. The method can then further include using an artificial intelligence/machine learning agent 5217 to predict traffic congestion and facilitate pre-allocation of resources among the plurality of cable modems for intelligent load balancing. In one or more embodiments, AI/ML agent 5217 is separate from the scheduler 5208 (e.g., on the CM 2) but communicates with it continuously using the channels 4228. For example, an agent on the modem CM 2 predicts future demand and facilitates pre-allocation of resources by informing the scheduler 5208 what traffic anticipates and the scheduler 5208 allocates resources based on input from all the cable modems. In this aspect, for example, AI/ML information from the cable modems comes back to the scheduler 5208 which has, or has access to, a processing function that makes decisions based on the AI/ML feedback it received from the cable modems.

As an aside, it is worth noting again that one or more embodiments move intelligence into DOCSIS core; and that in one or more embodiments, the CM is not backward compatible but the core is. Furthermore, one or more embodiments dynamically adjust OFDMA subcarriers for each CM based on demand as well as based on signal-to-noise ratio or similar metrics (e.g., leveraging Rx-MER or the like).

In another aspect, a non-transitory processor readable medium includes processor executable instructions which when executed by a processor cause the processor to perform a method for sharing a communications network between legacy and current versions of a data transfer standard (e.g., any one, some, or all of the method steps disclosed herein). The method can also include instantiating at least a portion of the scheduler component 5209. For example, software and/or firmware configures one or more processors in the vCMTS cluster to instantiate the scheduler 5208.

In a further aspect, an apparatus includes a memory, and at least one processor, coupled to the memory, and operative to facilitate sharing a communications network between legacy and current versions of a data transfer standard by carrying out any one, some, or all of the method steps disclosed herein, including instantiating at least a portion of the scheduler component 5209. For example, software and/or firmware configures the at least one processor in the vCMTS cluster to instantiate the scheduler 5208.

In another aspect, an exemplary system includes a virtual cable modem termination system cluster 5204 including a legacy version virtual cable modem termination system vCMTS D4, a current version virtual cable modem termination system vCMTS D5, and a scheduler component 5208 coupled to the legacy version virtual cable modem termination system and the current version virtual cable modem termination system. Also included are a plurality of legacy version cable modems CM1; a plurality of current version cable modems CM2; and a hybrid fiber-coaxial (HFC) communications network 101 coupling the virtual cable modem termination system cluster with the plurality of legacy version cable modems and the plurality of current version cable modems. The legacy version virtual cable modem termination system and the plurality of legacy version cable modems are configured in accordance with a legacy version of a data transfer standard. The current version virtual cable modem termination system and the plurality of current version cable modems are configured in accordance with a current version of the data transfer standard.

The scheduler component is configured to carry out or otherwise facilitate any one, some, or all of the method steps as described herein. For example, the scheduler component is configured to operate the communications network by assigning legacy version communications using a first modulation technique to a first portion of spectrum for communications in a first direction and by assigning current version communications using a second modulation technique to a second portion of the spectrum for communications in the first direction; to obtain, over a dedicated upstream signaling channel of the hybrid fiber-coaxial (HFC) communications network, from a given one of the current version cable modems, a request for a current version communications channel in the first direction using the second modulation technique; and to determine that additional bandwidth is required to accommodate the request. For example, the scheduler component is further configured to, responsive to the determining, signal, using a dedicated downstream signaling channel of the hybrid fiber-coaxial (HFC) communications network, the given one of the current version cable modems to expect the current version communications channel to be provided over the first portion of spectrum using time division multiple access (TDMA); and provide the current version communications channel by dividing, using TDMA, the first portion of spectrum between the legacy version communications using the first modulation technique and the current version communications using the second modulation technique.

In one or more embodiments, the system further includes a remote physical (“PHY”) device (RPD) 5212 in the hybrid fiber-coaxial (HFC) communications network (e.g., in a node 178 that transitions from fiber to coaxial cable). The current version virtual cable modem termination system sends traffic to the given one of the current version cable modems over the current version communications channel via the remote physical (“PHY”) device (RPD).

In one or more embodiments, the remote physical (“PHY”) device (RPD) includes a coexistence (CE) module 5216 that directs the traffic to the given one of the current version cable modems.

In a non-limiting example, the data transfer standard comprises DOCSIS; the legacy version of the data transfer standard comprises at least one of DOCSIS 3.0, DOCSIS 3.1, and DOCSIS 4.0; the current version of the data transfer standard comprises DOCSIS 5.0; the first modulation technique comprises orthogonal frequency-division multiplexing (OFDM); and the second modulation technique comprises orthogonal frequency division multiple access (OFDMA).

In one or more embodiments, the scheduler component is further configured to, during upgrade of the network from the legacy to the current versions of the data transfer standard, expand the second portion of the spectrum with respect to the first portion of the spectrum as a number of legacy version cable modems in the plurality of legacy version cable modems decreases during the upgrade (see, e.g., “Grows this Way” arrow in FIG. 8A).

One or more embodiments further include a plurality of artificial intelligence/machine learning agents 5217 located on the plurality of current version cable modems and trained to predict traffic congestion and facilitate (as discussed above) pre-allocation of resources among at least a portion of the plurality of cable modems for intelligent load balancing. One or more such embodiments can further include logic, accessible to the scheduler 5208, which is coupled to the plurality of artificial intelligence/machine learning agents 5217, and which is configured to pre-allocate the resources in accordance with the predictions. The logic could include, for example, a trained machine learning system; a series of IF-THEN-ELSE statements in a high-level language compiled into executable software or firmware; custom digital circuitry that implements logic similar to the series of IF-THEN _ELSE statements; or the like. The logic can be accessible to the scheduler, for example, by being located on the scheduler, or by being on a server coupled to the scheduler by a high-speed data link. To avoid clutter, FIG. 9 assumes the logic to be on the scheduler and it is not separately called out.

### System and Article of Manufacture Details

Embodiments of the invention can employ, for example, hardware aspects, software aspects, or a combination of hardware and software aspects. Software includes but is not limited to firmware, resident software, microcode, etc. One or more embodiments of the invention or elements thereof can be implemented in the form of an article of manufacture including a machine-readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

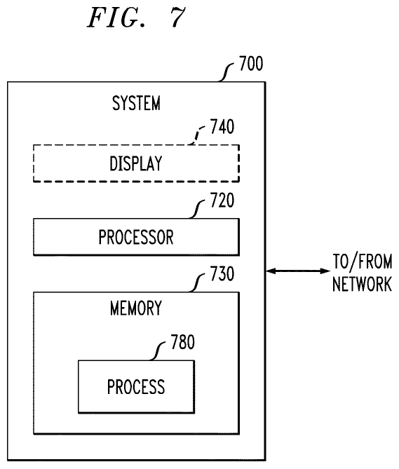

FIG. 7 is a block diagram of at least a portion of an exemplary system 700 that can be configured to implement at least some aspects of the invention, and is representative, for example, of one or more of the apparatuses, servers, or modules shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors, either concurrently (i.e., in parallel) or sequentially (i.e., in series).

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC or FPGA rather than using firmware. Display 740 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for sharing a communications network between legacy and current versions of a data transfer standard, the method comprising:
operating the communications network by using a scheduler component to assign legacy version communications using a first modulation technique to a first portion of spectrum for communications in a first direction and by using the scheduler component to assign current version communications using a second modulation technique to a second portion of the spectrum for communications in the first direction;
at the scheduler component, obtaining, over a dedicated upstream signaling channel, from a current version cable modem, a request for a current version communications channel in the first direction using the second modulation technique;
at the scheduler component, determining that additional bandwidth is required to accommodate the request;
responsive to the determining, with the scheduler component, signaling, using a dedicated downstream signaling channel, the current version cable modem to expect the current version communications channel to be provided over the first portion of spectrum using time division multiple access (TDMA); and
the scheduler component providing the current version communications channel by dividing, using TDMA, the first portion of spectrum between the legacy version communications using the first modulation technique and the current version communications using the second modulation technique.

2. The method of claim 1, further comprising sending traffic to the current version cable modem over the current version communications channel from a current version virtual cable modem termination system via a remote physical (“PHY”) device (RPD).

3. The method of claim 2, further comprising directing the traffic to the current version cable modem using a coexistence (CE) module in the remote physical (“PHY”) device (RPD).

4. The method of claim 3, wherein:
the data transfer standard comprises DOCSIS;
the legacy version of the data transfer standard comprises at least one of DOCSIS 3.0, DOCSIS 3.1, and DOCSIS 4.0;
the current version of the data transfer standard comprises DOCSIS 5.0;
the first modulation technique comprises orthogonal frequency-division multiplexing (OFDM);
the second modulation technique comprises orthogonal frequency division multiple access (OFDMA); and
the communications network comprises a hybrid fiber-coaxial (HFC) communications network.

5. The method of claim 4, wherein:
the network is connected to a plurality of cable modems including the current version cable modem, a plurality of additional current version cable modems, and a plurality of legacy version cable modems;
further comprising expanding the second portion of the spectrum with respect to the first portion of the spectrum.

6. The method of claim 5, wherein:
the method is carried out during upgrade of the network from the legacy to the current versions of the data transfer standard; and
the expanding of the second portion of the spectrum with respect to the first portion of the spectrum is carried out as a number of legacy version cable modems in the plurality of legacy version cable modems decreases during the upgrade.

7. The method of claim 1, wherein:
the network is connected to a plurality of cable modems including the current version cable modem, a plurality of additional current version cable modems, and a plurality of legacy version cable modems;
further comprising using an artificial intelligence/machine learning agent to predict traffic congestion and facilitate pre-allocation of resources among the plurality of cable modems for intelligent load balancing.

8. A non-transitory processor readable medium comprising processor executable instructions which when executed by a processor cause the processor to perform a method for sharing a communications network between legacy and current versions of a data transfer standard, the method comprising:
instantiating at least a portion of a scheduler component;
facilitating operation of the communications network by using the scheduler component to assign legacy version communications using a first modulation technique to a first portion of spectrum for communications in a first direction to and by using the scheduler component to assign current version communications using a second modulation technique to a second portion of the spectrum for communications in the first direction;
at the scheduler component, obtaining, over a dedicated upstream signaling channel, from a current version cable modem, a request for a current version communications channel in the first direction using the second modulation technique;
at the scheduler component, determining that additional bandwidth is required to accommodate the request;
responsive to the determining, with the scheduler component, signaling, using a dedicated downstream signaling channel, the current version cable modem to expect the current version communications channel to be provided over the first portion of spectrum using time division multiple access (TDMA); and
the scheduler component providing the current version communications channel by dividing, using TDMA, the first portion of spectrum between the legacy version communications using the first modulation technique and the current version communications using the second modulation technique.

9. An apparatus comprising:
a memory; and
at least one processor, coupled to the memory, and operative to facilitate sharing a communications network between legacy and current versions of a data transfer standard by:
instantiating at least a portion of a scheduler component;
facilitating operation of the communications network by using the scheduler component to assign legacy version communications using a first modulation technique to a first portion of spectrum for communications in a first direction to and by using the scheduler component to assign current version communications using a second modulation technique to a second portion of the spectrum for communications in the first direction;
at the scheduler component, obtaining, over a dedicated upstream signaling channel, from a current version cable modem, a request for a current version communications channel in the first direction using the second modulation technique;
at the scheduler component, determining that additional bandwidth is required to accommodate the request;
responsive to the determining, with the scheduler component, signaling, using a dedicated downstream signaling channel, the current version cable modem to expect the current version communications channel to be provided over the first portion of spectrum using time division multiple access (TDMA); and
the scheduler component providing the current version communications channel by dividing, using TDMA, the first portion of spectrum between the legacy version communications using the first modulation technique and the current version communications using the second modulation technique.

10. The apparatus of claim 9, wherein the at least one processor is further operative to send traffic to the current version cable modem over the current version communications channel from a current version virtual cable modem termination system via a remote physical (“PHY”) device (RPD).

11. The apparatus of claim 10, wherein the at least one processor is further operative to direct the traffic to the current version cable modem using a coexistence (CE) module in the remote physical (“PHY”) device (RPD).

12. The apparatus of claim 11, wherein:
the data transfer standard comprises DOCSIS;
the legacy version of the data transfer standard comprises at least one of DOCSIS 3.0, DOCSIS 3.1, and DOCSIS 4.0;
the current version of the data transfer standard comprises DOCSIS 5.0;
the first modulation technique comprises orthogonal frequency-division multiplexing (OFDM);
the second modulation technique comprises orthogonal frequency division multiple access (OFDMA); and
the communications network comprises a hybrid fiber-coaxial (HFC) communications network.

13. The apparatus of claim 12, wherein the network is connected to a plurality of cable modems including the current version cable modem, a plurality of additional current version cable modems, and a plurality of legacy version cable modems, and wherein the at least one processor is further operative to expand the second portion of the spectrum with respect to the first portion of the spectrum.

14. The apparatus of claim 13, wherein the at least one processor is further operative to expand the second portion of the spectrum with respect to the first portion of the spectrum as a number of legacy version cable modems in the plurality of legacy version cable modems decreases during an upgrade of the network from the legacy to the current versions of the data transfer standard.

15. The apparatus of claim 9, wherein the network is connected to a plurality of cable modems including the current version cable modem, a plurality of additional current version cable modems, and a plurality of legacy version cable modems, and wherein the at least one processor is further operative to use an artificial intelligence/machine learning agent to predict traffic congestion and facilitate pre-allocation of resources among the plurality of cable modems for intelligent load balancing.

16. A system comprising:
a virtual cable modem termination system cluster including a legacy version virtual cable modem termination system, a current version virtual cable modem termination system, and a scheduler component coupled to the legacy version virtual cable modem termination system and the current version virtual cable modem termination system;
a plurality of legacy version cable modems;
a plurality of current version cable modems; and
a hybrid fiber-coaxial (HFC) communications network coupling the virtual cable modem termination system cluster with the plurality of legacy version cable modems and the plurality of current version cable modems;
wherein:
the legacy version virtual cable modem termination system and the plurality of legacy version cable modems are configured in accordance with a legacy version of a data transfer standard;
the current version virtual cable modem termination system and the plurality of current version cable modems are configured in accordance with a current version of the data transfer standard; and
the scheduler component is configured to:
operate the communications network by assigning legacy version communications using a first modulation technique to a first portion of spectrum for communications in a first direction and by assigning current version communications using a second modulation technique to a second portion of the spectrum for communications in the first direction;
obtain, over a dedicated upstream signaling channel of the hybrid fiber-coaxial (HFC) communications network, from a given one of the current version cable modems, a request for a current version communications channel in the first direction using the second modulation technique;
determine that additional bandwidth is required to accommodate the request;
responsive to the determining, signal, using a dedicated downstream signaling channel of the hybrid fiber-coaxial (HFC) communications network, the given one of the current version cable modems to expect the current version communications channel to be provided over the first portion of spectrum using time division multiple access (TDMA); and
provide the current version communications channel by dividing, using TDMA, the first portion of spectrum between the legacy version communications using the first modulation technique and the current version communications using the second modulation technique.

17. The system of claim 16, further comprising a remote physical (“PHY”) device (RPD) in the hybrid fiber-coaxial (HFC) communications network, wherein the current version virtual cable modem termination system sends traffic to the given one of the current version cable modems over the current version communications channel via the remote physical (“PHY”) device (RPD).

18. The system of claim 17, wherein the remote physical (“PHY”) device (RPD) includes a coexistence (CE) module that directs the traffic to the given one of the current version cable modems.

19. The system of claim 18, wherein:
the data transfer standard comprises DOCSIS;
the legacy version of the data transfer standard comprises at least one of DOCSIS 3.0, DOCSIS 3.1, and DOCSIS 4.0;
the current version of the data transfer standard comprises DOCSIS 5.0;
the first modulation technique comprises orthogonal frequency-division multiplexing (OFDM); and
the second modulation technique comprises orthogonal frequency division multiple access (OFDMA).

20. The system of claim 19, wherein the scheduler component is further configured to expand the second portion of the spectrum with respect to the first portion of the spectrum.

21. The system of claim 20, wherein the scheduler component is further configured to, during upgrade of the network from the legacy to the current versions of the data transfer standard, expand the second portion of the spectrum with respect to the first portion of the spectrum as the number of legacy version cable modems in the plurality of legacy version cable modems decreases during the upgrade.

22. The system of claim 16, further comprising a plurality of artificial intelligence/machine learning agents located on the plurality of current version cable modems and trained to predict traffic congestion and facilitate pre-allocation of resources among at least a portion of the plurality of cable modems for intelligent load balancing.

23. The system of claim 22, further comprising logic accessible to the scheduler, coupled to the plurality of artificial intelligence/machine learning agents, and configured to pre-allocate the resources in accordance with the predictions.
